(19) United States
(12) Patent Application Publication
(10) Pub. No.: US 2026/0370995 A1
(43) Pub. Date: Nov. 19, 2026

(54) OPEN-TYPE EARPHONE

(71) Applicant: Move Company Limited, Tokyo To (JP)

(72) Inventor: Akihiko Hosaka, Tokyo (JP)

(73) Assignee: Move Company Limited, Tokyo To (JP)

(21) Appl. No.: 19/123,042

(22) PCT Filed: Oct. 20, 2023
(86) PCT No.: PCT/JP2023/038031

§ 371 Date: Apr. 21, 2025

(30) Foreign Application Priority Data
Oct. 21, 2022 (JP) 2022-169420

(51) Int. Cl. H04R 1/10

(52) U.S. Cl. CPC H04R 1/1016; H04R 1/1075; H04R 2460/09

(57) ABSTRACT

An objective of the present invention is to provide an open-type earphone that does not create a feeling of pressure on the ear, allows easy perception of surrounding environmental sounds, and offers high sound insulation with no sound leakage. The present invention provides an open-type earphone including an earphone body, which has a built-in speaker, and an acoustic duct, which extends obliquely from the earphone body to be inserted into the external auditory canal of an ear. A first communication passage that connects the speaker to the external auditory canal and a second communication passage that connects the atmosphere to the external auditory canal are formed in the acoustic duct.

### TECHNICAL FIELD

The present invention relates to an open-type earphone that can also take in surrounding environmental sound.

### BACKGROUND

Normally, sound vibration transmitted by air is transmitted to the eardrum inside an ear, and the vibration of the eardrum is transmitted to the cochlea via three auditory ossicles inside the eardrum. There is lymphatic fluid in the cochlea. The vibration of this lymphatic fluid is converted into an electrical signal and transmitted to the auditory nerve, and the brain recognizes this electrical signal as a sound.

Incidentally, some earphones that are worn in the user's ears reproduce sound by applying an audio signal to a speaker placed close to the ear, and these earphones are roughly divided into two types: inner-ear type and canal (earplug) type.

The inner-ear type earphones (see, for example, Patent Document 1) are used by being hooked onto a part of the ear called ear concha at the entrance of the ear, and have the advantage of not giving a feeling of pressure and making it easy to hear surrounding environmental sound. In contrast, the canal type earphones (see, for example, Patent Document 2) are used by inserting earplug-type earpieces into the ears, so they have the advantage of obtaining high sound insulation property and no sound leakage.

### PRIOR ART REFERENCE

### Patent Document

Patent Document 1: Japanese Patent Application Publication No. 2006-222492
Patent Document 2: Japanese Patent Application Publication No. 2019-145962

### SUMMARY

### Problems to be solved

However, the inner-ear type earphones have the disadvantage that the sound insulation property is low and sound leaks easily. In contrast, the canal type earphones have the disadvantage that the feeling of pressure on the ear is strong and it is difficult to hear the surrounding environmental sound because the earpiece is inserted deep into the ear.

The present invention has been made in view of the above-described problems, and an object thereof is to provide an open-type earphone that is securely worn without a feeling of pressure when fitted to a user's ear, makes it easy to hear the surrounding environmental sound, and has a high sound insulation property and no sound leakage.

### Means for Solving the Problems

In order to achieve the above object, the present invention provides an open-type earphone including: an earphone body, which at least has a built-in speaker; and an acoustic duct, which extends obliquely from the earphone body to be inserted into an external auditory canal of an ear at least deeper than a tragus, wherein an earring is attached to the acoustic duct, wherein one end of the earring abuts against the tragus of the ear, and other end of the earring abuts against an inner wall of an ear concha, and a first communication passage communicating the speaker with the external auditory canal of the ear and a second communication passage communicating atmosphere with the external auditory canal of the ear are formed in the acoustic duct.

### Effects

According to the present invention, since the acoustic duct is formed with the first communication passage communicating the speaker with the external auditory canal of the ear and the second communication passage communicating the atmosphere with the external auditory canal of the ear, the surrounding environmental sound is introduced into the external auditory canal of the user's ear through the second communication passage. Thus, the user can simultaneously hear the speaker sound introduced into the external auditory canal through the first communication passage and the surrounding environmental sound introduced into the external auditory canal through the second communication passage. Since the speaker sound passes through the first communication passage and further passes through the second communication passage to escapes into the atmosphere, the path becomes longer, and the leakage of the speaker sound to the outside (sound leakage) is prevented. Furthermore, the speaker sound can be heard clearly even in a place where the environmental sound is loud, and there is no touch noise or echo of the user's own voice.

In addition, in the open-type earphone, the acoustic duct is inserted into the external auditory canal of the user's ear at least deeper than the tragus, and the earring is attached to the acoustic duct, wherein one end of the earring abuts against the tragus of the ear, and the other end of the earring abuts against the inner wall of the ear concha. Therefore, the earring and the acoustic duct are sandwiched between the tragus of the ear and the ear concha, and the open-type earphone is securely worn without a feeling of pressure when fitted to the user's ear.

Therefore, the open-type earphone according to the present invention can be securely worn without a feeling of pressure when fitted to the user's ear, and allows the user to enjoy only the advantages of both the inner-ear type earphone and the canal type earphone while eliminating the disadvantages of each.

### BRIEF DESCRIPTION OF DRAWINGS

FIG. 1 is a perspective view of an open-type earphone according to the present invention as viewed from obliquely above;

FIG. 2 is a perspective view of the open-type earphone according to the present invention as viewed from obliquely below;

FIG. 3 is a side view of the open-type earphone according to the present invention;

FIG. 4 is a cross-sectional side view of the open-type earphone according to the present invention;

FIG. 5 is an exploded perspective view of the open-type earphone according to the present invention;

FIG. 6 is a cross-sectional view of a user's ear portion showing a use state of the open-type earphone according to the present invention;

FIG. 7 is a perspective view of an open-type earphone according to another embodiment of the present invention as viewed from obliquely below.

### DETAILED DESCRIPTION

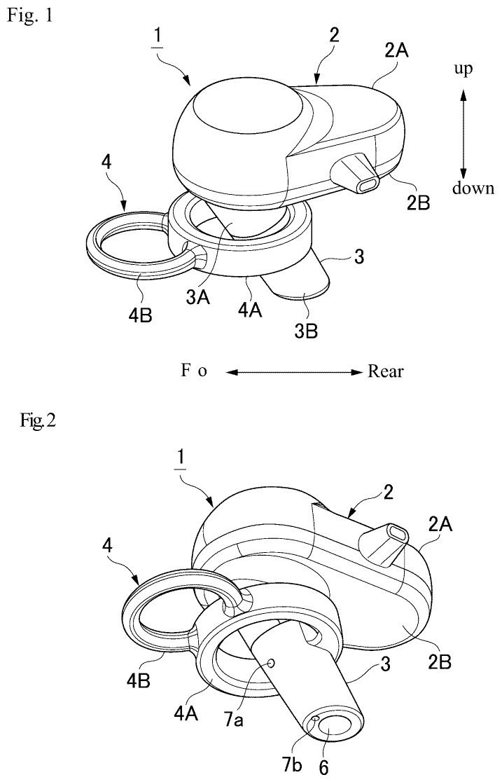

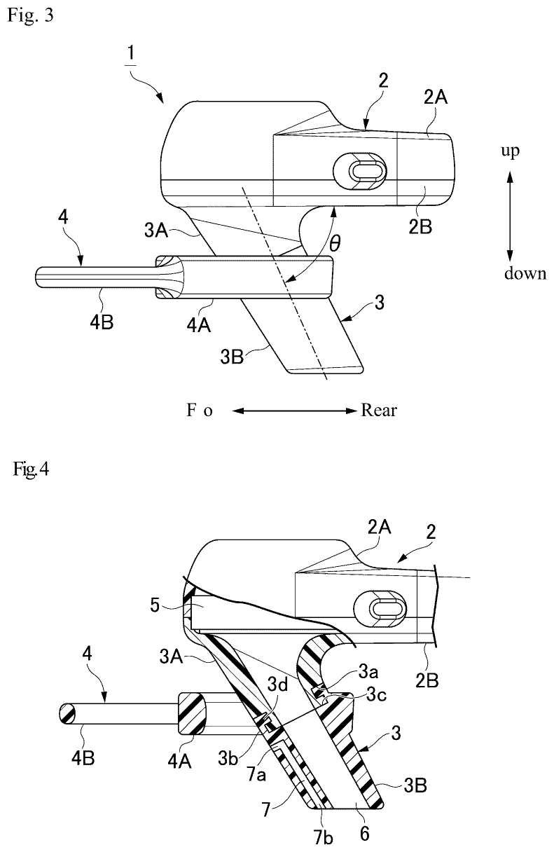

Hereinafter, embodiments of the present invention will be described based on the accompanying drawings. It is to be noted that, in the following description, the arrow directions shown in FIG. 1 and FIG. 3 refer to the “front-rear” direction and the “up-down” direction, respectively.

An open-type earphone 1 according to the present embodiment includes: an earphone body 2 that is elliptical in a plan view; a cylindrical acoustic duct 3 that extends obliquely downward from the earphone body 2; and an earring 4 that extends forward (leftward in FIG. 1 to FIG. 6) from the acoustic duct 3.

The above earphone body 2 is a case body configured by joining and integrating the upper case 2A and the lower case 2B, and an upper duct piece 3A constituting a portion of the acoustic duct 3 extends integrally from a front end portion of the lower case 2B so as to be inclined downward and obliquely rearward at a predetermined angle θ (see FIG. 3). Here, the acoustic duct 3 is vertically divided into two, and is composed of the upper duct piece 3A formed integrally with the lower case 2B and the cylindrical lower duct piece 3B attachable to and detachable from the upper duct piece 3A. Hereinafter, the attachment/detachment structure of the upper duct piece 3A and the lower duct piece 3B will be described.

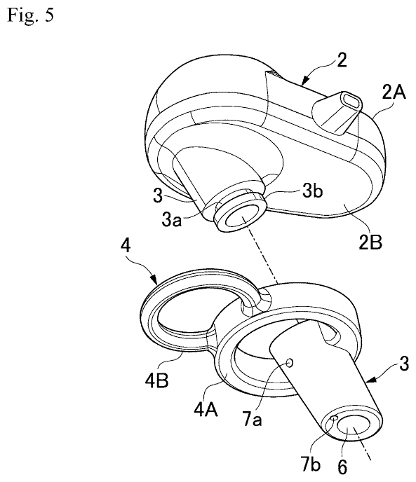

That is, as shown in FIG. 4 and FIG. 5, a fitting groove 3a is formed over the entire circumference at the outer periphery of the lower end of the upper duct piece 3A, and an annular fitting protrusion 3b is formed below (lower end portion) the fitting groove 3a of the upper duct piece 3A. In addition, a fitting groove 3c is formed over the entire circumference at the inner periphery of the upper end portion of the lower duct piece 3B, and an annular fitting protrusion 3d is formed at the inner periphery of the upper end of the lower duct piece 3B. Therefore, the outer periphery of the lower end portion of the upper duct piece 3A is fitted from above into the inner periphery of the upper end portion of the lower duct piece 3B, and as shown in FIG. 4, the fitting protrusion 3b of the upper duct piece 3A is fitted into the fitting groove 3c of the lower duct piece 3B, and the fitting protrusion 3d of the lower duct piece 3B is fitted into the fitting groove 3a of the upper duct piece 3A, whereby the upper duct piece 3A and the lower duct piece 3B are connected and integrated.

Here, in the present embodiment, an inclination angle θ of the acoustic duct 3 with respect to the earphone body 2 is set to θ=60°, but this inclination angle θ should be set to 60°±10° (50° to 70°). In addition, in the present embodiment, the earphone body 2 (upper case 2A and lower case 2B) and the acoustic duct 3 are made of a hard resin such as ABS resin, which has high rigidity.

Incidentally, in addition to the speaker 5, a substrate on which various electronic components are mounted or the like is accommodated in the earphone body 2, but the speaker 5 is disposed directly above the acoustic duct 3 inside the earphone body 2 at a position where it does not come into contact with the user's ear, as shown in FIG. 4. By disposing the speaker 5 at such a position, even if the diameter of the speaker 5 is made sufficiently large to improve the sound quality of the speaker 5, this speaker 5 will not interfere with the ear. It is to be noted that, in the present embodiment, although the speaker 5 is horizontally accommodated in the earphone body 2, this speaker 5 may be vertically disposed and accommodated.

The earring 4 extends substantially horizontally forward from the front surface of the lower duct piece 3B of the acoustic duct 3, but this earring 4 is configured by connecting and integrating two circular ring-shaped rings 4A and 4B, and is detachably attached to the earphone body 2 together with the lower duct piece 3B of the acoustic duct 3. It is to be noted that the earring 4 is made of flexible silicone or elastomer that is elastically deformable.

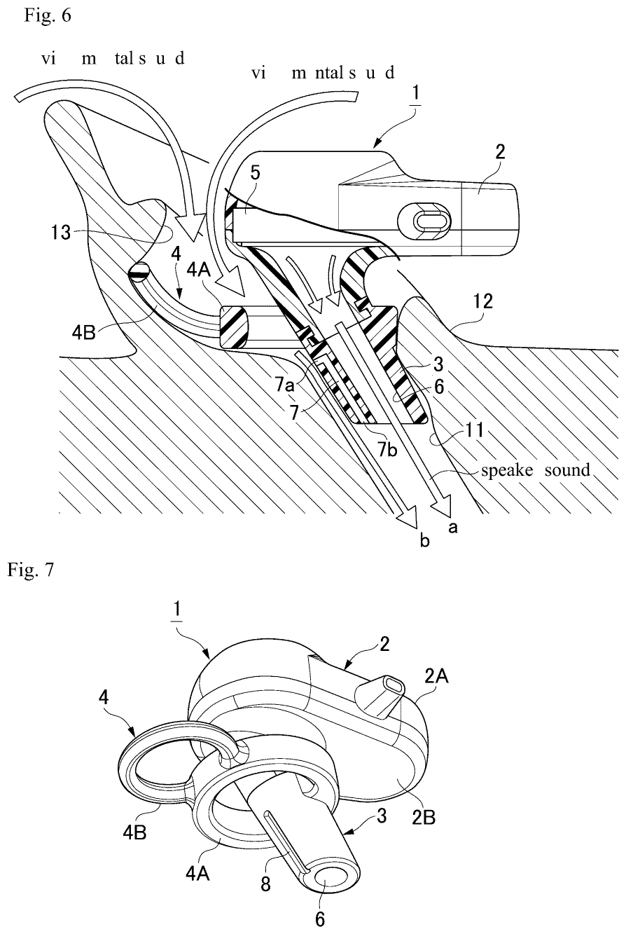

In the open-type earphone 1 according to the present embodiment, as shown in FIG. 4 and FIG. 6, a circular hole-shaped first communication passage 6, which communicates the speaker 5 built in the earphone body 2 with the external auditory canal 11 of the ear (see FIG. 6) when the user wears the open-type earphone 1 on the ear, is formed at an axial central portion of the acoustic duct 3. That is, an upper end of the first communication passage 6 opens to the earphone body 2, and a lower end of the first communication passage 6 opens to the external auditory canal 11 of the ear. In addition, a second communication passage 7, which communicates the atmosphere with the external auditory canal 11 of the ear, is formed on the front surface side (left side in FIG. 4) of the lower duct piece 3B of the acoustic duct 3. As shown in FIG. 2 and FIG. 5, this second communication passage 7 has an upper end that opens to the atmosphere through a circular hole 7a formed at the upper end portion of the lower duct piece 3B, and a lower end that opens to the external auditory canal 11 of the ear through a circular hole 7b formed in the bottom surface of the lower duct piece 3B.

It is to be noted that, the above describes the configuration of the open-type earphone 1 that is worn on one (left or right) ear of the user, but the configuration of the open-type earphone 1 that is worn on the other (right or left) ear is exactly the same as that of the above one, so illustrations and descriptions thereof will be omitted.

Here, a state in which the open-type earphone 1 according to the present embodiment is worn on the user's ear is shown in FIG. 6, and the open-type earphone 1 is worn in a direction in which the end surface of the earring 4 (ring 4A) abuts against the tragus (antilobium) 12 of the ear. That is, the open-type earphone 1 is worn on the user's ear by inserting the acoustic duct 3 into the external auditory canal 11 of the ear, and at this time, the earring 4 abuts against the tragus 12 of the ear. Then, since the earring 4 is pressed by the tragus 12, the earring 4 is pressed against the inner wall 13 of the ear concha, and the ring 4B is elastically deformed to bend in an arc shape. As a result, the earring 4 and the acoustic duct 3 are sandwiched between the tragus 12 of the ear and the inner wall 13 of the ear concha, and the open-type earphone 1 is securely worn in a state where it is fitted to the user's ear.

As described above, when the open-type earphones 1 are fitted and worn on the left and right ears of the user, the sound emitted from the speaker 5 (speaker sound) passes through the first communication passage 6 formed at the center portion of the acoustic duct 3, and is transmitted to the cochlea via the eardrum, as shown by arrow a in FIG. 6, the vibration of the lymphatic fluid of the cochlea is converted into an electrical signal and transmitted to the auditory nerve, and the brain recognizes this electrical signal as a sound. Also, the surrounding environmental sound passes through the second communication passage 7 formed in the acoustic duct 3, and is transmitted to the cochlea via the eardrum, as shown by arrow b in FIG. 6, the vibration of the lymphatic fluid of the cochlea is converted into an electrical signal and transmitted to the auditory nerve, and the brain recognizes this electrical signal as a sound.

As described above, in the open-type earphone 1 according to the present embodiment, the acoustic duct 3 is formed with a first communication passage 6 that communicates the speaker 5 with the external auditory canal 11 of the ear and a second communication passage 7 that communicates the atmosphere with the external auditory canal 11 of the ear, so that the surrounding environmental sound is introduced into the external auditory canal 11 of the user's ear through the second communication passage 7. Thus, the user can simultaneously hear the speaker sound introduced into the external auditory canal through the first communication passage 6 and the surrounding environmental sound introduced into the external auditory canal 11 through the second communication passage 7. Then, since the speaker sound passes through the first communication passage 6 and further passes through the second communication passage 7 to escapes into the atmosphere, the path becomes longer, and leakage of the speaker sound to the outside (sound leakage) is prevented. Furthermore, the speaker sound can be heard clearly even in a place where the environmental sound is loud, and there is no touch noise or echo of the user's own voice.

In addition, the open-type earphone 1 according to the present embodiment is worn by inserting the acoustic duct 3 into the external auditory canal of the user's ear, and is securely worn on the user's ear by the earring 4, so the acoustic duct 3 does not press the ear and can give a comfortable wearing feeling to the user. In the present embodiment, since the lower duct piece 3B of the acoustic duct 3 and the earring 4 are integrally formed and they are configured to be attachable to and detachable from the upper duct piece 3A (earphone body 2), the earring 4 can be easily replaced with one that is compatible with the size and shape of the ear concha or the external auditory canal 11 of the user. It is to be noted that the earring 4 may be configured in a single form, and the single earring 4 may be detachably attached to the acoustic duct 3.

As a result of the above, according to the open-type earphone 1 of the present embodiment, it is possible to enjoy only the advantages of both inner-ear type earphone and canal type earphone while eliminating the disadvantages of each.

In the above embodiment, the second communication passage 7 is formed inside the side wall of the acoustic duct 3 (lower duct piece 3B), but as shown in FIG. 7, the second passage may be configured by a linear groove 8 formed along the vertical direction at a portion of the outer periphery of the acoustic duct 3.

It should be noted that the present invention is not limited to the above-described embodiments, and various modifications are possible within the scope of the claims and the scope of the technical ideas described in the specification and drawings.

### EXPLANATION OF REFERENCE SYMBOLS

1: open-type earphone, 2: earphone body, 2A: upper case, 2B: lower case,
3: acoustic duct, 3A: upper duct piece of acoustic duct, 3B: lower duct piece of acoustic duct,
3a: fitting groove of upper duct piece, 3b: fitting protrusion of upper duct piece,
3c: fitting groove of lower duct piece, 3d: fitting protrusion of lower duct piece, 4: earring,
4A, 4B: ring, 5: speaker, 6: first communication passage, 7: second communication passage,
7a, 7b: circular hole of second communication passage, 8: groove (second communication passage), 11: external auditory canal,
12: tragus, 13: inner wall of ear concha

1. An open-type earphone, comprising: an earphone body, which at least has a built-in speaker; and an acoustic duct, which extends obliquely from the earphone body to be inserted into an external auditory canal of an ear at least deeper than a tragus, wherein
the acoustic duct is divided into two: an upper divided piece that is integrally formed with the earphone body; and a lower divided piece that is attachable to and detachable from the upper divided piece,
an earring is attached to the lower divided piece of the acoustic duct, wherein one end of the earring abuts against the tragus of the ear, and other end of the earring abuts against an inner wall of an ear concha, and
a first communication passage communicating the speaker with the external auditory canal of the ear and a second communication passage communicating atmosphere with the external auditory canal of the ear are formed in the acoustic duct.

2. The earphone according to claim 1, wherein a lower end of the first communication passage opens to the external auditory canal of the ear, a lower end of the second communication passage opens to the external auditory canal of the ear, and the first communication passage and the second communication passage do not communicate with each other inside the acoustic duct.

3. The earphone according to claim 1, wherein an inclination angle θ of the acoustic duct with respect to the earphone body is set to be 50° to 70°.

4. The earphone according to claim 1, wherein the earring is configured by connecting and integrating two circular ring-shaped rings, and is made of flexible silicone or elastomer that is elastically deformable.

5. The earphone according to claim 1, wherein the second communication passage is formed on a front surface side of the lower divided piece of the acoustic duct
